(19) United States
(12) Patent Application Publication
(10) Pub. No.: US 2008/0086259 A1
(43) Pub. Date: Apr. 10, 2008

(54) Navigation sign

(76) Inventor: Valerie Cody, (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/578,083

(22) PCT Filed: Apr. 12, 2005
(86) PCT No.: PCT/IE05/00040

§ 371 Date: Jul. 23, 2007

(30) Foreign Application Priority Data
Apr. 13, 2004 (IE) S2004/0259

(51) Int. Cl. G01C 21/00

(52) U.S. Cl. 701/200; 701/211

(57) ABSTRACT

This invention relates to signs and cartography, and provides a sign which makes it easier for tourists to find their way around a town or city. In particular the invention provides a navigation sign (1) having a plurality of components. The components are suitable for incorporation into a paving system. The components include an indicator component (2) having a directional indicator, and a receiving section (4, 5, 6, 7). The receiving section is shaped to receive the indicator component (2) and permits relative rotation of the indicator component. The indicator component may be rotated to indicate a particular direction and then fixed in place.

### FIELD OF THE INVENTION

The present invention relates to the field of navigational signs and in particular to a sign, which is suitable for incorporation in a pavement.

### BACKGROUND TO THE INVENTION

The problems of navigating one's way in an unknown area are well known and familiar to most people. Various solutions have been designed to assist people in finding their way around an unfamiliar area, the simplest of which is the signpost. However, signposts are only useful when they indicate the direction to the place of interest. If the posted directions mean nothing to the tourist reading them, the signpost provides no help to a lost tourist. In addition, signposts are typically limited to placement at junctions. Signposts can frequently be unsightly. A further problem associated with signposts is their reliability. Frequently, signs will point in the wrong direction having being turned by the wind or other force.

The map is another example of a tool to assist navigation. Commonly, tourist maps of towns are provided at a scale to be of benefit to a pedestrian tourist. They are however of limited benefit when lost, unless one has the good fortune to recognise a landmark or spot a street name and then find the feature on the map.

One system which overcomes this known difficulty, involves the strategic placement of pre-printed maps in stands at locations around a town. Each map is suitably marked so as to indicate the location of the stand, e.g. a highlighted circle with the words you are here. While this assists the hapless tourist in finding where they are on a map, it does not assist them in progressing their journey as the orientation of the user is uncertain with respect to the map.

Consequently, there is a need for a navigational aid, which overcomes the known problems of the prior art.

### SUMMARY OF THE INVENTION

This need and others are satisfied by the present invention, in which a first embodiment provides a navigation sign having a plurality of components which are suitable for incorporation into a paving system, the components comprising a first indicator component having a directional indicator, and a receiving section, which is suitably shaped to receive the first indicator component and permit relative rotation of the indicator component to the receiving section. The indicator component may be any suitable shape, but is preferably circular.

In an alternative embodiment, the indicator component comprises a toothed circle with corresponding features on the receiving section. In this alternative embodiment the number of possible directions for the directional indicator is limited by the number of teeth.

The first indicator component may have a central aperture defined therein, preferably circular, for receiving a second indicator component. The second indicator component may include a directional indicator which may indicate the direction to a pre-determined location, for example the town center.

The navigation sign may further comprise one or more location identifier components. The location identifiers may identify one or more of the following; a map grid reference, a named location, a marker on an associated map or a location reference.

In a preferred embodiment, the receiving section is segmented.

Optionally, the receiving section may comprise one or more location identifier components. The receiving section may have a substantially rectangular outer shape, preferably square. The receiving section may have a substantially circular inner shape. The navigation sign may comprise one or more further directional indicators, preferably circular in shape. In one embodiment, a directional indicator may be provided for indicating the direction to the location of another navigational sign, for example identified by a particular marker. In another embodiment, a directional indicator may be provided indicating the direction to the location of a subsequent marker.

The navigation sign may further comprise a framework (former) section, optionally segmented, which is suitably shaped to accomodate the receiving section. The framework, receiving section and/or indicator components of the sign may have indicative matter printed, embossed, engraved or stamped or integrally formed thereon.

In use, the receiving section or framework section is aligned with adjoining components of a paving system, whereas the indicator component is aligned with a direction indicated on an associated map.

In one embodiment the components of the navigation sign may be made from concrete, metal or other durable material suitable for incorporation in a street pavement.

In an alternative embodiment, the components may be made from a less durable material, for example carpet, cork or plastic, suitable for incorporation in a flooring system.

This invention also extends to a system combining the at least one navigational signal herein before described with at least one associated map, wherein the at least one navigational sign provides an orientation for the at least one associated map. Additionally, the map may identify the position of one or more location identifiers.

A second embodiment of the invention provides a method of creating a navigation sign comprising the steps of positioning a receiving section, the receiving section defining an aperture, inserting an indicator component, rotating the indicator component to align the directional indicator with a direction indicated on an associated map. Once aligned, the indicator component may be fixed with respect to the receiving section.

The method may further comprise the step of positioning a framework suitably shaped to receive the receiving section.

The method may further comprise the step of positioning a second indicator component within an aperture of the first indicator component, rotating the second indicator component to align the directional indicator with a pre-determined location. Once aligned, the second indicator component may be fixed with respect to the first indicator component.

The method may comprise the removing of an existing surface section, for example of paving or flooring material, to receive the navigation sign.

The method may include the further step of adding location information to the navigation sign. The location information may include one or more of the following; the location, the locality, a grid reference, or a marker from an associated map.

Further objects, features and advantages of the present invention will become apparent from the following description and drawings.

### BRIEF DESCRIPTION OF THE DRAWINGS

The invention will now be described with reference to the accompanying drawings in which:

FIG. 1 is an exemplary embodiment of a navigate on sign according to the invention, and

FIG. 2 is an exemplary map for use in combination with the navigational sign of FIG. 1.

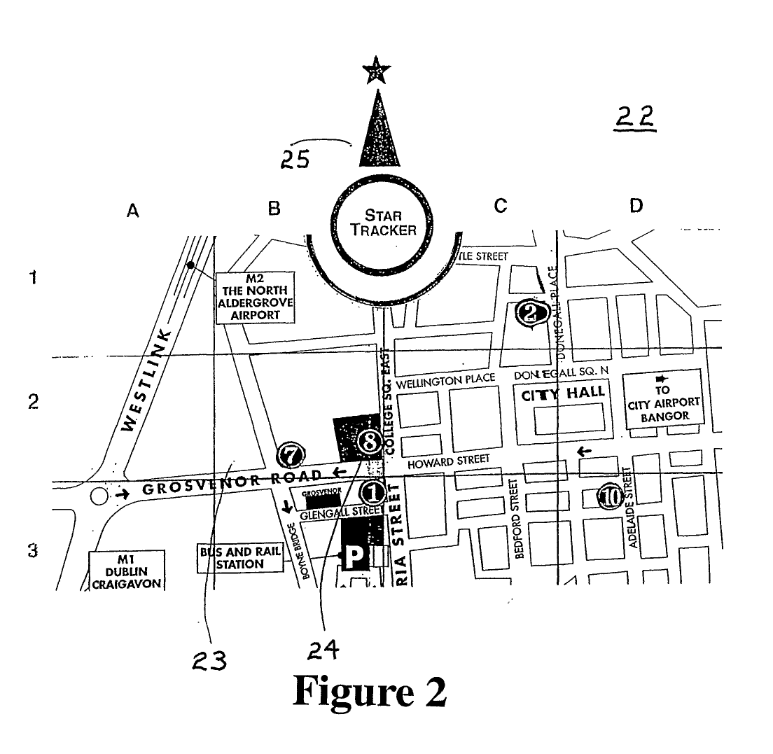

### DETAILED DESCRIPTION OF THE DRAWINGS

The present invention provides a navigational sign, optionally a paving stone, which functions as multi-component location and/or direction indicator. Its primary purpose is to make it simple for a pedestrian to navigate a small area, for example a city center, without having to ask for directions, although it also has application in many locations other than cities.

When assembled and fixed on the ground, the navigation sign of the present invention, used in conjunction with an associated specially marked map, allows a person to simply and immediately, establish their exact location, orientate themselves relative to all other parts of the map, and identify a direct route to any other location on the map.

Even without a map, it is still possible to orientate oneself using the information contained on a navigation sign of the present invention.

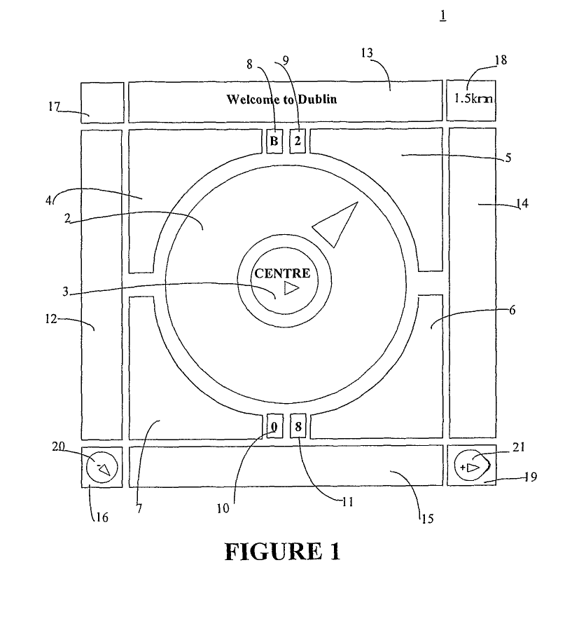

A navigation sign according to the invention, as illustrated in the exemplary embodiment of FIG. 1, comprises a plurality of individual components. The navigation sign 1 is intended for placement in a horizontal plane. Preferably, the navigation sign is suitable for and intended for incorporation into a paving system (not shown).

The navigation sign comprises two primary pieces, a receiving section and a first indicator component 2, preferably circular. The receiving section is segmented and formed as an outer group of segments (pieces) 4, 5, 6, 7. This group of pieces defines an inner circular aperture, into which the circular indicator component 2 may be inserted. The circular indicator incorporates a pointer, which may be engraved, inscribed, printed or attached thereto which can be rotated relative to the receiving section in any desired direction in the horizontal plane. Once rotated to a desired direction, the circular indicator component may be fixed in that position with cement or any other suitable fixing material. The fixing material may be placed in advance of the indicator component and/or receiving sections.

As envisaged, the navigation sign is intended for use as a paving stone, i.e. the navigation sign is intended to in use replace one or more existing paving stones. The navigation sign is such that its individual components may be used to carry information and specially shaped to allow for that information to be presented simply and accurately.

The receiving section may be formed as a singular piece. Although, in the exemplary sign shown in FIG. 1, the receiving section comprises four corner pieces 4, 5, 6, 7 defining the corners of a rectangular outline. Interposed between the corner pieces may be one or more blocks, forming location identifiers 8,9,10,11 having printed or otherwise inscribed thereon location information. For ease of production each block is printed with a single character. The blocks may then be combined if necessary to form the required location identifier. The location identifiers may identify one or more of the following; a map grid reference, a named location, a marker on an associated map or a location reference. In the example shown, the upper location identifier, formed by the combination of blocks 8 and 9, is a grid reference for a grid 23 on an associated map 22. The lower location identifier, formed by the combination of blocks 10 and 11, identifies a location 24 on the associated map 22 which is within the grid reference identified by the upper location identifier.

The pointer on the circular indicator component 2 indicates the direction of a reference (mercator) line on an associated map 22.

The circular indicator component 2 may have a central circular aperture defined therein for receiving a second circular indicator component 3.

The second circular indicator component 3 incorporates a secondary pointer which may be used to indicate the direction to a pre-determined location, for example the centre of a town. It may be inserted into the aperture of the circular indicator and rotated until the desired direction is reached. The second circular indicator component 3 may then be fixed in place using cement or other means.

To allow for more information to be carried, the navigational sign may comprise additional pieces, specially shaped to allow for that information to be presented simply and accurately. In the example shown, a former section is provided which surrounds the receiving section. The former section (framework) comprises one or more components 12, 13, 14, 15, 16, 17, 18, 19 which may be used to ensure that the shape of the navigation sign may be adapted to fit easily into an existing paving pattern. The use of a former section provides further surfaces for the inclusion of location or marketing information. This information may be printed, embossed, engraved or stamped or integrally formed thereon on the components of the former section. This information may include the name of the district in which the sign is laid, distances from specific places or corporate messages in the event of sponsorship.

In the example shown, square corner components 16, 17, 18, 19 are provided in the former section separated by rectangular side pieces 12, 13, 14, 15. Two of the square corner components 16, 19 have centralised circular apertures defined therein. These circular apertures 20, 21 may be used to hold further directional indicators. These further indicators may be used to indicate the directions to the locations of a previous marker and a next marker in a sequence of markers, for example to identify a tourist trail in a city.

The navigation sign is preferably incorporated in new sections of pavement. However, the navigation sign may also be incorporated into existing pavements by first removing a section of pavement of a suitable shape to receive the navigation sign. It will be appreciated that for reasons of convenience, the depth of the navigation sign should equal the depth of the surrounding paving material.

The navigation sign components may be made from any material that is durable enough to withstand pedestrian traffic—ideally concrete or metal, or a combination thereof, but should circumstances dictate, individual components can be made of any chosen material.

The invention also has applications in other areas, for example at conferences, shows, or shopping centres. In these circumstances the sign may be made of less durable materials, which are suitable for incorporation into existing paving systems e.g. carpet, cork or plastic.

The fact that the navigation sign is fixed (cemented) in position makes it tamper proof and therefore completely reliable, while its design characteristics ensure that it will not degrade any existing paving design. Similarly it is not prone to misalignment from the wind and is not prone to vehicle impacts. Unlike conventional signposts, it is not limited to placement at junctions.

The primary pointer incorporated on the first indicator component 2 which, having been rotated, is then fixed in a position corresponding to the direction of a reference line drawn on an associated map 22, so as to enable users to establish both their position and orientation using the map and sign. It also helps people without maps to orientate themselves.

The corner pieces of the former section 16, 17, 18, 19 may be used to show distance from the city centre, or other location. The distances may be rounded, for example to the nearest 0.5 km, to allow the pieces to be manufactured in a mass production process.

Framework pieces to hold markers in position and, if desired, to carry additional information, may be added to fill a large area.

The navigation sign or paving stone marker of the present invention is designed to operate with an official tourist map of the city (or other area) in which it is to be laid. Such maps are invariably printed in a rectangular format.

When a navigation sign (paving stone marker) is being laid, the primary pointer incorporated on the indicator component 2 is fixed to point to a direction corresponding to a line down at right angles to the upper edge of the map 22 and represented on the map by a printed direction logo 25.

On encountering a navigation sign (paving stone), one may read the grid reference number from the top of the paving stone and relate it to the corresponding sector on the map i.e. grid reference number B2 on the navigation sign equals sector B2 23 on the map 22. One may then read the paving stone number (location marker) on the bottom and locate that number 24 within the grid sector already identified on the map i.e. marker no 08 24 in sector B2 23. It is now possible to establish one's exact position on the map.

To navigate, one holds the map 22 with the printed direction logo 25 pointing away from you. The map may then be rotated so as to align the direction logo 25 with the primary pointer on the central circular indicator component of the paving stone. As one stands in this position everything shown on the map to the left of the paving stone is to one's left hand side; likewise, everything to the right of the paving stone is actually to one's right side, and everything that appears above the marker on the map, or below it, is in front or behind you respectively.

Using the present invention for navigation, one can immediately establish the direction of any chosen location and, by monitoring other similar paving stones en route, be sure to arrive at that location.

Thus the present invention allows users to find their exact location and orientation. This tells them precisely which direction to take to any other place on the map.

Even without a map, the fact that the paving stone points in two direction—both constant—one to the top of the official map, and the other to the city centre, it is possible to orientate oneself with reasonable accuracy by simple deduction.

For example, if it is known that the primary pointer on the paving stone always points to the top of the map, regardless of the location, and the secondary pointer points to the city centre. It is obvious, that if, for example, the two markers are pointing in exactly the same direction, one is standing on a line that passes directly through the city centre, which is in front of one: likewise if the two markers are diametrically opposed, one is on the same line, but the centre is behind one. Thus even without a map one may confidently navigate using a network of navigation signs according to the present invention.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A navigation sign having a plurality of components which are suitable for incorporation into a paving system, the components comprising:
a first indicator component having a directional indicator, and
a receiving section, which is shaped to receive the indicator component and permits rotation of the indicator component relative to the receiving section.

2. The navigation sign of claim 1, wherein the first indicator component has a central aperture defined therein for receiving a second indicator component.

3. A method of creating a navigation sign comprising the steps of:
positioning a receiving section, the receiving section defining an aperture,
inserting a first indicator component into the aperture of the receiving section,
rotating the indicator component to align it with a direction on an associated map, and
fixing the indicator component with respect to the receiving section.

4. (canceled)

5. (canceled)
